(19) United States
(12) Patent Application Publication
(10) Pub. No.: US 2014/0038146 A1
(43) Pub. Date: Feb. 6, 2014

(54) METHOD AND SYSTEM OF TEAMING UP VIA SOCIAL NETWORK SERVICE FOR ACTIVITY COACHING

(71) Applicant: International Business Machines Corporation, Armonk, NY (US)

(72) Inventors: Pao-Chuan LIAO, Taipei (TW); June-Ray LIN, Taipei (TW); Sreeram RAMAKRISHNAN, Cambridge, MA (US); Kai-Quan ZHENG, Taipei (TW)

(73) Assignee: Inrternational Business Machines Corporation, Armonk, NY (US)

(21) Appl. No.: 13/955,067

(22) Filed: Jul. 31, 2013

(30) Foreign Application Priority Data
Jul. 31, 2012 (TW) 101127574
Jul. 31, 2012 (TW) 101127575

(51) Int. Cl. G09B 19/00

(52) U.S. Cl. CPC G09B 19/00
USPC 434/236

(57) ABSTRACT

A method and system of teaming via a social network service for activity coaching include creating a stage model that comprises a first and second stages, wherein a value of a performing parameter for use in the first stage is less than a value of the performing parameter for use in the second stage; receiving initial activity data of users at social network service; determining users involved in the first stage according to initial activity data; teaming the users involved in the first stage; communicating to users via social network service the value of the performing parameter for use in the second stage; setting a team goal to achieve the value; waiting for feedback from the users; determining whether the team goal is achieved; moving the users in the same team to the second stage; and providing rewards to the users, if the determination is affirmative.

### CROSS-REFERENCE TO RELATED APPLICATIONS

This application is based upon and claims priority from prior Taiwan Patent Applications 101127574 and 101127575, both filed on Jul. 31, 2012, the entire disclosures of which are hereby incorporated by reference herein.

### BACKGROUND OF THE INVENTION

1. Field of the Invention

The present invention relates to a method and system of teaming via social network service for activity coaching.

2. Description of the Related Art

Take medical service as an example, after making a diagnosis to patients, physicians not only give prescriptions, but also give medical care instructions which suggest that the patients should undergo specified health care activities, for example, going on a diet, taking exercise, or adjusting lifestyle. As with certain patients, such as those patients diagnosed with obesity or diabetes, the aforesaid home-based health care activities are usually more effective than medication in treating the patients' diseases.

In view of this, prior arts, such as U.S. Pat. No. 7,287,031 and U.S. Pat. No. 7,821,404, put forth methods for enhancing patients' compliance to medical care instructions.

Furthermore, the aforesaid home-based health care activities are characterized in that they have to be carried out gradually and persistently until they become part of the lifestyle to thereby be conducive to improvement of health or prognosis. For example, even if a physician makes a diagnosis that an obese patient has to take exercise as much as jogging for 3 kilometers per day in order to cure the patient's illness. However, it is actually impossible for a patient who has hardly taken exercise before to immediately start jogging every day; otherwise the patient will sustain sports injury.

### SUMMARY OF THE INVENTION

Pill taking is a simple one-time action. By contrast, health care activities have to be carried out repeatedly, persistently, and gradually until they develop and become part of the lifestyle; hence, their compliance requirement is strict, not to mention that patients have to make great efforts psychologically and physiologically in order to achieve the goals of the health care activities. In view of this, in an aspect, the present invention provides a method and system pertaining to activity coaching so as to help patients develop health care activities smoothly.

Existing private human-based activity coaching is not only time-consuming, laborious, and costly, but also ineffective in taking care of plenty of coaching objects. In view of this, in an aspect, the present invention puts forth a method and system of automated activity coaching. In another aspect, the present invention puts forth a method and system of activity coaching via social network service, so as to effectuate activity coaching by means of a social group.

In addition to encouraging or urging patients to undertake activities, activity coaching is for use in recommending an appropriate activity by considering and evaluating the condition of individual patients. Take workout as an example, it is feasible to advise patients to go jogging or swimming. Yet another purpose of activity coaching is to assist individual patients in setting stage-specific activity goals, for example, jogging three kilometers every day this week, jogging five kilometers every day next week, and so on. In view of this, in yet another aspect, the present invention enables users to set appropriate stage-specific activity goals by means of automation.

The “social network service” described herein is based on a “social network Website”. In this Website, social network members define the relationships between each other, and perform other activities, including giving opinions, playing games, and undertaking creative work jointly. For the details of the “social network service” described herein, visit the Wikipedia Webpage
http://en.wikipedia.org/wiki/Social_networking_service

Preferably, the “social network service” described herein features a reward scheme whereby rewards are given to users conditionally. The rewards include virtual or honorable rewards, such as virtual badges, better ratings, bonus points, and the “like” provided on Facebook; in other words, tangible rewards are not required. However, it is important that the aforesaid virtual or honorable rewards can be recorded during the social network service. Examples of rewards are demonstrated in Gash (i.e., Game Cash) launched by Gamania Digital Entertainment Co., or in Gash+® developed by GASH PLUS (TAIWAN) Company Limited.

Although the “activities” described herein are mostly explained hereunder in terms of fitness workout, persons skilled in the art understand that the present invention is not limited thereto. For example, the “activities” described herein are also applicable to serving general educational purposes, such as reading or extracurricular activities, as long as the “activities” can be designed to have at least a quantifiable “performing parameter”, such as the number of time the “activities” are carried out weekly, or the duration of each instance of the “activities”. The “performing parameter” described herein depends on the way of carrying out the specific activity rather than the contents of the activity per se. Hence, different activities, such as workout and reading, can have the same performing parameter (for example, carrying out an activity thrice a week, or carrying out an activity for a total of 100 minutes a week).

Unlike the “performing parameter”, the “level” described herein correlates with the contents of the activity per se. For instance, workout can come in two forms, namely low-level jogging and high-level rock climbing. Alternatively, reading could be put into two categories, namely low-level newspaper browsing and high-level classic literature perusal.

According to an embodiment of the present invention, the present invention provides a method of teaming via social network service for activity coaching. The method comprises the steps of: creating a stage model according to at least a performing parameter of an activity, wherein the stage model comprises a first stage and a second stage, wherein a value of the at least a performing parameter for use in the first stage is less than a value of the at least a performing parameter for use in the second stage; receiving initial activity data of each of a plurality of users at social network service, and determining the users involved in the first stage according to the initial activity data and the value of the at least a performing parameter for use in the first stage; teaming the users involved in the first stage; communicating to the users teamed in the same team via the social network service the value of the at least a performing parameter for use in the second stage, setting a team goal to achieve the value, and waiting for feedback from the users in the same team; determining whether the team goal is achieved according to the at least a performing parameter value replied by the users teamed in the same team, and moving the users in the same team to the second stage if the determination is affirmative; and providing rewards to the users in the same team according to a predetermined reward scheme at the social network service, if the determination is affirmative.

The present invention discloses a computer program product stored on a computer-available medium. The computer program product comprises a computer-readable program for implementing the aforesaid methods when executed on a computer.

According to another embodiment of the present invention, the present invention provides a computer system comprising a memory and a processing unit. The memory stores a computer executable instruction. The processing unit executes the computer executable instruction so as to implement the aforesaid methods.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The following description, the appended claims, and the embodiments of the present invention further illustrate the features and advantages of the present invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram of a computer system according to specific embodiments of the present invention.

FIG. 2 illustrates a stage model according to specific embodiments of the present invention.

FIG. 3 is a flowchart of an embodiment of the present invention.

FIG. 4 is a flowchart of another embodiment of the present invention.

### DETAILED DESCRIPTION OF THE EMBODIMENTS

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment”, and similar language throughout this specification may, but do not necessarily, all refer to the same embodiment.

As will be appreciated by one skilled in the art, the present invention may be embodied as a computer system, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

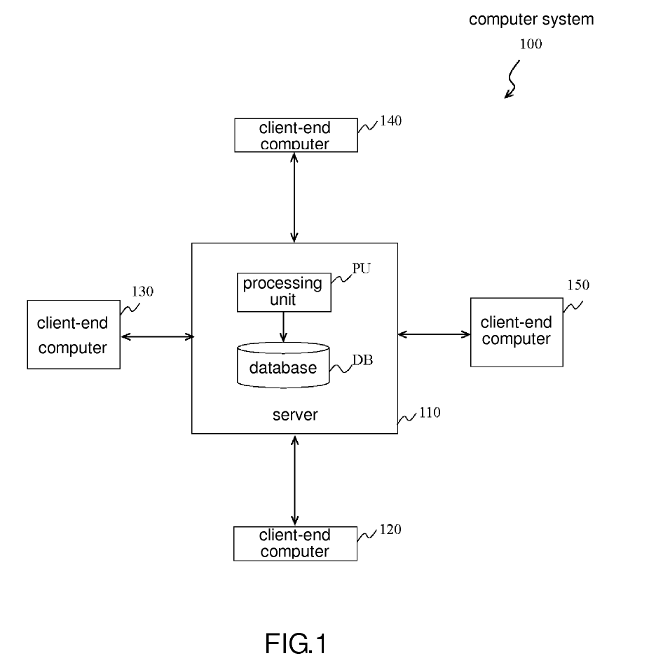

Referring now to FIG. 1 through FIG. 4, apparatus, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

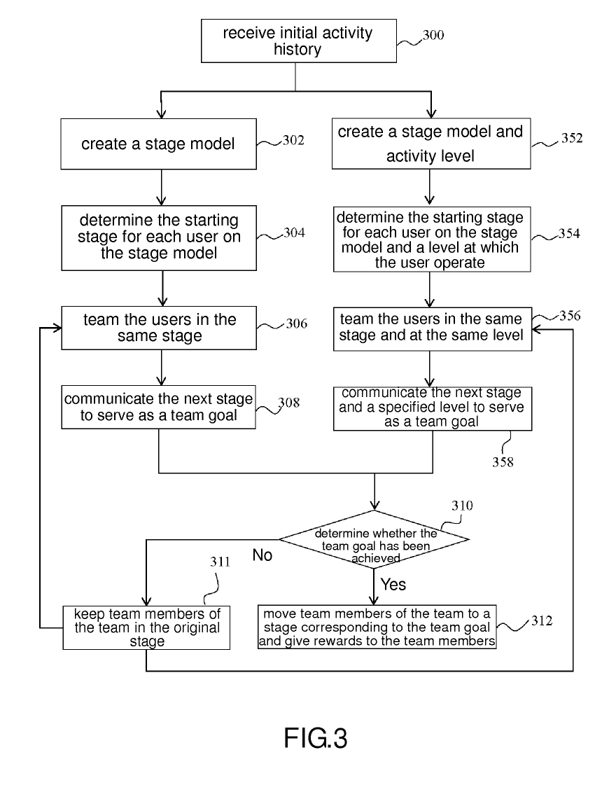

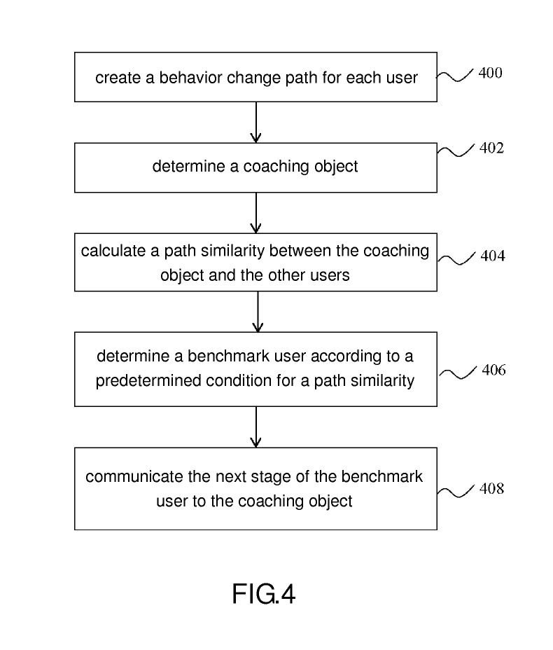

FIG. 1 is a schematic view of the structure of a system 100 according to a specific embodiment of the present invention, such that FIG. 1 enables persons skilled in the art to gain insight into the present invention rather than restricts the scope of the present invention. In an exemplary embodiment, the system 100 includes a server 110, one or more client-end computers 120, 130, 140, 150 (such as a personal computer, a notebook computer, or a mobile electronic device). The server 110 has a processing unit PU and a database DB to execute methods illustrated through FIG. 3 through FIG. 4 The client-end computers 120, 130, 140, 150 are connected to the information center server 110 via a network (not shown).

According to the present invention, the client-end computers 120, 130, 140, and 150 are electronic products for executing applications to provide an instant message, an e-mail, or a short message, or electronic products for executing other applications to dispatch information, such as desktop computers, notebook computers, terminal apparatuses, mobile phones, or personal digital assistants. The client-end computers can also execute applications like word processing services or browsers. In an exemplary embodiment, the client-end computer is a general desktop computer including: a processor for executing various applications; a storing device for storing various information and program codes; a display device; a communication and output/input device for use as an interface for communication with the users; and peripheral elements or other elements with specific purposes. In other embodiments, the present invention may also be implemented in other manners and thus require more other devices/elements or less other devices/elements.

Likewise, the server 110 can come in the form of a general computer, a computer with a special purpose, a high-level workstation, or a large host computer as needed, without affecting the implementation of the present invention. The required network can also come in a connection of any type, including a wide area network (WAN) or a local area network (LAN) with static IP, or a temporary connection to the Internet through an Internet service provider (ISP), whether by cable connection or by wireless connection. Persons skilled in the art are able to understand that the network can also have other hardware and software elements (such as an additional computer system, a router, or a firewall) not shown in the accompanying drawings.

Each of the client-end computers for executing various applications (such as an instant message system, an e-mail system, or a short message system) for dispatching information includes an information plug-in and thus can interact with the server 110.

It should be noted that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The present invention is hereunder illustrated with several simple embodiments and is especially exemplified by health activities. As mentioned earlier, persons skilled in the art should understand that the present invention is not limited to the embodiments below.

Stage Model

The “stage model” described herein is designed to make progress step by step, wherein stage-specific goals with respect to patients or persons being coached involved in different stages are set. With the stage model of the present invention, different stages are designed according to at least a “quantifiable performing parameter” for use in the activities. Hence, each stage has its own unique value for a performing parameter; furthermore, each stage may have values of at least two performing parameters. As regards a specific performing parameter, the low to high stages match the low to high values of the specific performing parameter, respectively. The quantity of the stages varies as needed, and the present invention is not limited thereto.

For the sake of illustration, the present invention is hereunder exemplified by a stage model, wherein the stage model has two activity performing parameters, namely frequency S and accumulated duration D. Frequency S is defined as the number of instances of activity carried out per week, whereas accumulated duration D is defined as the total number of weeks each of which sees the persistent execution of the activity in a specific number of instances (say two instances). The stage model is illustrated with Table 1 below.

TABLE 1

| Stage | Parameter (frequency S; accumulated duration D) |
|---|---|
| 1 | S = 1; D = 1 (less than once a week; lasts for a period of time |
| | shorter than one week) |
| 2 | S = 2; D = 1 (twice a week; lasts for one week) |
| 3 | S = 3; D = 1 (thrice a week; lasts for one week) |
| 4 | S = 4; D = 1 (four times a week; lasts for one week) |
| 5 | S = 5; D = 1 (five times a week; lasts for one week) |
| 6 | S = 5; D = 2 (five times a week; lasts for two weeks) |
| 7 | S = 5; D = 3 (five times a week; lasts for three weeks) |
| 8 | S = 5; D = 4 (five times a week; lasts for four weeks or more) |

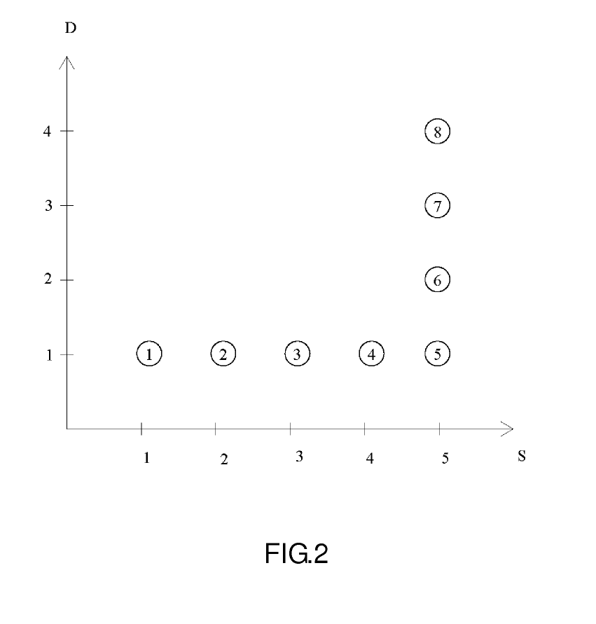

Referring to FIG. 2, frequency S is depicted with the x-axis, whereas accumulated duration D is depicted with the y-axis, such that the stage model illustrated with Table 1 is expressed in terms of two-dimensional coordinates. Hence, persons skilled in the art understand that different stage models can be designed even by means of two identical performing parameters (frequency S and accumulated duration D).

### First Embodiment: Using a Team as a Unit

FIG. 3 is a flowchart of an illustrative embodiment of the present invention regarding a computer implemented method for performing activity coaching with a system 100 shown in FIG. 1, in particular, teaming two or at least two users to perform activity coaching, wherein the activity is exemplified by fitness workout.

FIG. 1 merely depicts a single server 110 for providing social network service and activity coaching. In practice, the present invention is not restrictive of the quantity of the server 110, and the servers 110 do not necessarily provide exactly the same service. Hence, it is feasible that some servers 110 are in charge of social network service, whereas the other servers 110 are in charge of activity coaching, such that the former and the latter can exchange data by means of any of the aforesaid forms of networks.

Step 300: this step entails performing initialization preparation work for collecting users' profile information, especially those information which is about specific activities. In this step, the server 110 uses the social network service it maintains to invite users to feed back or post, by means of client-end computers 120, 130, 140, 150, life history which takes place within a specific period of time (determined by the server 110 independently), especially the life history about specific activities (i.e., activity history), and store the life history-related data in a database DB. Take workout as an example, users may feed back the name and the contents (such as jogging for three kilometers or swimming for one hour) of workout, or the amount of calories consumed by workout, at any time (such as “on certain dates, or on a regular basis, for example, the morning, the afternoon, or the evening on every day or every Sunday). The information provided by users does not necessarily come in the form of a specific format; hence, it can also be provided in a natural language, wherein the server 110 is also capable of processing natural languages.

Step 302: the server 110 creates the stage model illustrated with Table 1 or FIG. 2 and stores the stage model in the database DB. The stage model illustrated with Table 1 or FIG. 2 is also applicable to any activities other than “workout”.

Step 304: since situation varies from user to user, the purpose of this step is to determine the starting point of each user on the stage model (Table 1 or FIG. 2) to serve as a basis of subsequent teaming. In this step, frequency S and accumulated duration D of the workout carried out are determined according to information related to the time and contents in workout history and provided by each user in step 300, such that the users are assigned to the corresponding stages (stages 1-8) on the stage model created in step 302.

Persons skilled in the art understand that the above description is directed to a simplified example. However, in other embodiments not shown, the activity history provided by users may not directly match the parameters (such as frequency S and accumulated duration D) of the stage model, whereas the server 110 may need to make reference to a predetermined comparative table or algorithm (which may also be stored in the database DB), so as to assign the users to the corresponding stages on the stage model. Hence, in this step, those users with workout history (step 300) manifesting similar frequency S and accumulated duration D are assigned to the same stage.

To perform the subsequent steps, it is feasible to consider adjusting the headcount of the users involved in each stage. For example, in the situation where only one user is involved in the pre-adjustment stage 3 and thus is insufficient to perform the subsequent steps, it is feasible to move the user to stage 2, thereby allowing the user from stage 3 and the users from stage 2 to undergo the subsequent steps together.

Step 306: the purpose of this step is to team at least two users assigned to the same stage (such as stage 2) for carrying out activity coaching. The advantage of having activity coaching carried out by a team rather than an individual is widely disclosed in academic literature and thus is not described in detail herein for the sake of brevity. In this step, the headcount of each team is preferably identical (say three), but the present invention is not limited thereto.

As regards the way of teaming, all the users in the same stage can be randomly teamed. Preferably, users are teamed according to personal information, such as age, gender, and education, previously provided by the users at social network service, so as to facilitate the communication and mutual encouragement between the users found in the same team and characterized by similarity in a specific dimension.

Furthermore, users can be teamed according to workout history provided by the users (step 300). In step 304, users with similar workout history are assigned to the same stage. In step 306, users with more similar workout history in the same stage are assigned to the same team.

In another embodiment, in addition to personal information and workout history, users in the same stage (such as stage 2) are teamed according to ratings given to each other among the users or teamed according to relationships (such as colleagues, friends, and family members) between the users at the social network service, wherein the relationships are predefined by the server 110, or specified and named by users. For more details, make reference to the operation of Circle developed by Google+®.

From another perspective, ratings or relationships can also be used to judge the similarity of two users. The larger the sum of the ratings given to each other between the users, the more similar the two users are. Furthermore, similarity varies with relationship in the same way. Hence, ratings or relationships can be introduced into the considerations or algorithms regarding determination of the similarity between users according to personal information and workout history.

The present invention is not restrictive of similarity algorithms for use in determining the similarity between two users as well as clustering algorithms for use in performing clustering according to similarity, which are well known by persons skilled in the art and thus are not described in detail herein for the sake of brevity.

If algorithms are employed, the aforesaid personal information, workout history, ratings, and relationships will have to be numerically expressed in order to be introduced into automation algorithms.

Since one of the purposes of teaming is to allow team members to communicate with each other and encourage each other easily, there must not be too many team members in each team. In this regard, preferably, an upper limit of the headcount of each team is set (to be four, for example) and introduced into the aforesaid clustering algorithms.

Step 308: the server 110 sends via the social network service it maintains (and by intranet-based messages, emails, or any other appropriate communication means) to the users involved in the same stage (such as stage 2) and teamed in the same team in step 306 an invitation to group games. The invitation to group games first sets forth setting the team goal of group games to the value of the performing parameter (i.e., frequency S=3; accumulated duration D=1 (i.e., thrice per week; lasts for one week)) for use in the next stage (stage 3), and then sets forth a list of team members and rules of group games, for example, it is only when the execution result of all the team members meets the team goal, i.e., frequency S=3 and accumulated duration D=1, that the team goal is deemed achieved, or, in other words, group games are done. In doing so, team members can encourage each other and supervise each other to thereby be further motivated to achieve the activity goal. Furthermore, the invitation specifies a game's duration, and requires the users to reply to the execution result within the games duration. The aforesaid rule of group games serves an exemplary purpose, and the present invention is not limited thereto.

Step 310: after the specified games duration has passed, the server 110 performs a statistical analysis on the execution result fed back by the users via the client-end computers 120, 130, 140, 150. The way of the users' feeding back the execution result is the same as the way of the users' feeding back workout history in step 300. Hence, there can be no difference in the user end between step 300 and step 310, but the present invention is not limited thereto.

Likewise, it is possible that the workout history fed back by the users in step 310 fails to match frequency S and accumulated duration D directly, whereas the server 110 may need to make reference to a predetermined comparative table or algorithms in order to calculate the corresponding frequency S and accumulated duration D and thereby determine whether the team goal has been achieved, that is, whether the execution result of all the team members meets the team goal, namely frequency S=3 and accumulated duration D=1.

Step 312: if the determination in step 310 is affirmative, move all the team members of the team from stage 2 on the stage model to stage 3, and provide rewards to the users in the same team according to a predetermined reward scheme at the social network service. Afterward, the process flow of the method goes back to step 306 so as to repeat step 306 through step 312. Hence, the users who have been moved from stage 2 to stage 3 and the other users who are involved in stage 3 could be teamed and then are being moved to stage 4 together.

In another aspect, if the determination in step 310 is negative, keep all the team members of the team in the initial stage 2 on the stage model (step 311). Afterward, the process flow of the method goes back to step 306. Hence, all the users involved in stage 2 are teamed once again to challenge stage 3, and step 306 through step 312 are repeated.

### Variant Embodiment: Activity Level

Referring to FIG. 3, a variant embodiment based on the first embodiment is put forth to further limit the levels of activity. The variant embodiment is distinguished from the first embodiment by the steps below:

Step 352: step 352 follows step 300 and is similar to step 302 except that in step 352 the server 110 further creates a level of activity and stores it in the database DB. As described above, the “level” described herein relates to the contents of the activity per se (but does not relate to any performing parameter). For example, depending on how many calories it consumes, workout comes in three levels: low level, intermediate level, and high level. Alternatively, depending on its skill requirement, workout falls into three categories: basic, advanced, and professional. In this regard, the basis of levels and the quantity of levels are adjustable as needed, and the present invention is not restrictive thereof.

Step 354: step 354 follows step 352 and is similar to step 304. To give further considerations to the different situations of the users, step 354 entails identifying the levels (including low level, intermediate level, and high level) at which the users in the same stage operate, according to the information (such as the amount of calories consumed) contained in workout history provided by the users and received in step 300. Hence, in step 354, the users, who have been assigned to same stage and provide workout history indicative of similar amounts of consumed calories, are assigned to the same level. Persons skilled in the art understand that the above description is directed to a simplified example. However, in other embodiments not shown, the activity history provided by users may not directly match the basis of differentiation of levels (such as the amount of calories consumed,) whereas the server 110 may need to make reference to a predetermined comparative table or algorithms so as to identify the levels at which the users in the same stage operate.

The users assigned to the same stage and the same level in step 354 are more similar to each other than the users assigned to the same stage in step 304 and thus communicate with each other and give encouragement to each other better.

Step 356: step 356 follows step 354 and is similar to step 306. Step 356 is distinguished from step 306 in that step 356 entails teaming the users assigned to the same stage (such as stage 3) and the same level (such as an intermediate level) in order to carry out activity coaching.

Step 358: step 358 follows step 356 and is similar to step 308. Step 358 is distinguished from step 308 in that step 358 entails adding activity level to the team goal of group games described in an invitation thereto. Hence, to achieve the team goal, the level of the activities carried out by team members has to conform with the level created in the team goal. Preferably, the level created in the team goal can be consistent with the level (such as an intermediate level) attributed to the team members of the team and previously identified in step 354, and can be adjusted as needed (for example, in response to a heat wave, the level created in the team goal can be adjusted downward to the low level with a view to preventing heat stroke). Step 358 is followed by step 310 and step 312. Afterward, the process flow of the method goes back to step 356, and step 356 through step 312 are repeated.

### Second Embodiment: Behavior Change Path

FIG. 4 is a flowchart of another illustrative embodiment of the present invention regarding a computer implemented method for performing activity coaching with the system 100 shown in FIG. 1 and, in particular, performing activity coaching according to a behavior change path of a benchmark user on the stage model. Preferably, the present invention is illustrative rather than restrictive of the method illustrated with FIG. 4 and based on the method illustrated with FIG. 3. In particular, the method illustrated with FIG. 4 and the method illustrated with FIG. 3 apply to the same stage model (as shown in Table 1).

Behavior Change Path

Referring to FIG. 3, the three steps, namely step 304, step 311, and step 312, depict how the server 110 determines the stages in which a user is operating with the stage model, according to the activity data (such as the activity history of step 300 and the execution result of step 310) provided by the users (see Table 1 or FIG. 2). Hence, given step 304, step 311, and step 312, the variation in the stage of the same user on the stage model forms a behavior change path (as illustrated with Table 2 below), wherein step 311 and step 312 can be performed repeatedly, such that the behavior change path extends accordingly.

For the sake of illustration, a round is herein defined as a cycle in which a user provides activity data to the server 110 (for example, either the activity history of step 300 or the execution result of step 310) and the server 110 determines the stage involving the user (such as one of step 304, step 311, and step 312). Each round is accompanied by a round of behavior change path. For example, if server 110 carries out step 304 once, step 311 twice, and step 312 once to a user in sequence to determine the stage that involves the user, four rounds of behavior change path with respect to the user will be created.

Step 400: in this step, the server 110 obtains the user's activity data, creates a behavior change path accordingly, and stores the behavior change path in the database DB to serve as a subsequent reference. Since the users join the activity at different points in time and make different degrees of progress thereafter, the users' behavior change paths vary in length (that is to say, the quantity of rounds varies). Preferably, though the present invention is not limited to, step 400 is carried out instantly and repeatedly to thereby obtain the latest behavior change path of each user. An example of a single user's behavior change path (six rounds thereof) is illustrated with Table 2 below.

TABLE 2

| Number of Rounds | Stage |
|---|---|
| 1 | stage 2 |
| 2 | stage 2 |
| 3 | stage 3 |
| 4 | stage 4 |
| 5 | stage 5 |
| 6 | stage 5 |

Step 402: in this step, the server 110 determines an object to receive activity coaching (hereinafter referred to the coaching object) and fetches the latest behavior change path (four rounds thereof, while the fifth round has not been determined yet) of the coaching object from the database described in step 400, as shown in Table 3 below.

TABLE 3

| Number of Rounds | Stage |
|---|---|
| 1 | stage 1 |
| 2 | stage 2 |
| 3 | stage 3 |
| 4 | stage 4 |
| 5 | (not yet determined) |

Step 404: in this step, the server 110 makes reference to the latest behavior change path of the coaching object (see Table 3) and calculates a path similarity between the coaching object and the other users described in the database described in step 400 so as to identify a benchmark user serving as a reference for the coaching object.

In an embodiment, one of the purposes of the method is to assist the coaching object in setting the goal in the next round (that is, the fifth round). Other users who only have four rounds of (or even shorter) behavior change paths cannot serve as a reference for the fifth round. Hence, it is feasible to rule out such users beforehand in order to enhance the efficiency of calculation.

Furthermore, in case of the other users' 5 rounds of (or even longer) behavior change path (see Table 2), a path similarity is calculated between the first four rounds of behavior change path and the coaching object's four rounds of behavior change path (see Table 3). For more details of a path similarity, read the description below.

Step 406: in the aforesaid step 404, a path similarity between each of the other users and the coaching object is calculated. By contrast, in step 406, the server 110 has to select a benchmark user from all the other users, wherein the basis of the selection is that: a path similarity between the benchmark user and the coaching object meets a predetermined condition. For example, if a predetermined condition is set to the highest degree of path similarity among all the users, then the server 110 can select the benchmark user having the closest behavior change path to the coaching object according to the predetermined condition. Furthermore, it is feasible that a predetermined condition is defined as a range of path similarity.

Step 408: after selecting the benchmark user, the server 110 provides, via the social network service it maintains, the value of the performing parameter for use in the stage involving the benchmark user in the next round (that is, the fifth round) to the coaching object so as to serve as the goal of the coaching object in the next round (the fifth round). For example, given the benchmark user's behavior change path as shown in Table 2, its fifth round occurs in stage 5. Referring to the stage model illustrated with Table 1, the value(s) (frequency S=5; accumulated duration D=1 (five times per week; lasts for one week)) of the performing parameter(s) in stage 5 can be obtained, and thus the server 110 can provide the value(s) of the performing parameter(s) to the coaching object.

Path Similarity

Referring to FIG. 4, the benchmark user's behavior change path is provided to the coaching object to serve as a basis for setting a goal, whereas a path similarity is for use in selecting the benchmark user. Hence, the method illustrated with FIG. 4 presumes a certain degree of similarity in a past activity development course between the benchmark user and the coaching object, such that not only is it reasonable to use the benchmark user's behavior change path as a basis for setting a goal of the coaching object, but the basis is convincing to the coaching object.

The way of calculating a path similarity is not limited by the present invention but is designed or adjusted as needed. In an embodiment, values of stage pertaining to the behavior change paths of the other users and the coaching object in each stage are treated as two data series, such that a similarity between the two data series is calculated. Take four rounds of behavior change path enumerated in Table 2 and Table 3 as an example, the two data series are (2, 2, 3, 4) and (1, 2, 3, 4), respectively. The way of calculating a similarity of the two data series is known in existing similarity algorithms and thus is not described herein for the sake of brevity.

In another aspect, the values of stage pertaining to the behavior change paths in each stage are actually derived from activity data (such as the activity history of step 300 and the execution result of step 310) given by the users to the server 110. Hence, in another embodiment, a path similarity is not directly calculated with the values pertaining to the behavior change paths in each stage; instead, a path similarity is directly calculated with the activity data given by the users to the server 110 in each round. If the activity data comprises at least two parameters (such as frequency S, accumulated duration D, the amount of calories consumed, and skill requirement), a path similarity between the coaching object and the other users will be calculated by means of a multi-dimensional vector space model, for example. Furthermore, as described in step 306, after being turned into numerals, the ratings or relationships between the coaching object and the other users can also be applied to the calculation of a path similarity.

In another embodiment, calculation of a path similarity entails calculating a similarity between the coaching object and the other users in each round and then calculating the sum of the similarities. Take four rounds of behavior change path as an example, calculation of a path similarity entails calculating the first round of similarity, the second round of similarity, the third round of similarity, and the fourth round of similarity and then calculating the sum of the similarities to obtain the path similarity. Different weights can be assigned to the aforesaid rounds of similarities when calculating a path similarity. For example, a subsequent round of similarity (such as the third round of similarity) is given a larger weight than a preceding round of similarity (such as the second round of similarity) is.

Each round of similarity is calculated, using the activity data provided by the users to the server 110 in each round. Likewise, if the activity data comprises at least two parameters (such as frequency S, accumulated duration D, the amount of calories consumed, and skill requirement), a similarity between the coaching object and the other users in each round will be calculated by means of a multi-dimensional vector space model, for example.

Similarity calculation is required in determining a stage (step 304), determining a level (step 354), teaming (steps 306, 356), and identifying a benchmark user (step 406) according to the aforesaid embodiments of the present invention. After studying the above description, persons skilled in the art understand that the purpose of the aforesaid ways of calculating a similarity is to identify a coaching object's peers in different dimensions, and thus the present invention will not be restrictive of specific similarity algorithms, provided that the aforesaid purpose is fulfilled.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

What is claimed is:

1. A computer implemented method of teaming via a social network service for activity coaching, the method comprising the steps of:
(a) creating a stage model according to at least a performing parameter of an activity, wherein the stage model comprises a first stage and a second stage, wherein a value of the at least a performing parameter for use in the first stage is less than a value of the at least a performing parameter for use in the second stage;
(b) receiving initial activity data of each of a plurality of users at a social network service, and determining the users involved in the first stage according to the initial activity data and the value of the at least a performing parameter for use in the first stage;
(c) teaming the users involved in the first stage;
(d) communicating to the users teamed in a same team in step (c) via the social network service the value of the at least a performing parameter for use in the second stage, setting a team goal to achieve the value, and waiting for feedback from the users in the same team;
(e) determining whether the team goal is achieved according to the at least a performing parameter value replied by the users teamed in the same team in step (c), and moving the users in the same team to the second stage if the determination is affirmative; and
(f) providing rewards to the users in the same team according to a predetermined reward scheme at the social network service, if the determination is affirmative.

2. The method of claim 1, wherein step (c) through step (f) are repeated.

3. The method of claim 1, wherein the at least a performing parameter comprises frequency or accumulated duration.

4. The method of claim 1, wherein step (c) further comprises teaming according to similarity in the initial activity data of the users involved in the first stage.

5. The method of claim 1, wherein step (c) further comprises teaming according to ratings given to each other among the users involved in the first stage.

6. The method of claim 1, wherein step (c) further comprises teaming according to relationships between the users involved in the first stage at the social network service.

7. The method of claim 1, wherein step (c) further comprises teaming according to a predetermined upper limit of team member headcount.

8. The method of claim 1, wherein the activity has a plurality of predetermined levels, wherein step (c) further comprises identifying the users at a first level in the plurality of levels according to the initial activity data of the users involved in the first stage and teaming the identified users at the first level, and wherein step (d) further comprises communicating to the users teamed in the same team in step (c) the at least a performing parameter value for use in the second stage and a level in the plurality of levels, and setting the team goal to achieve the parameter value and the level.

9. The method of claim 1, wherein, in step (a), the stage model further comprises a third stage, and the at least a performing parameter value for use in the second stage is less than the at least a performing parameter value for use in the third stage, and wherein, after step (e), the method further comprises the steps of:
(g) selecting a user involved in the second stage from a plurality of users if the determination in step (e) is affirmative, and teaming the users;
(h) communicating to the users teamed in the same team in step (g) the at least a performing parameter value for use in the third stage to serve as another team goal, and waiting for feedback from the users in the same team;
(i) determining whether the team goal has been achieved according to the at least a performing parameter value fed back from the users in the same team in step (h), and moving the users in the same team to the third stage if the determination is affirmative; and
(j) providing rewards to the users in the same team according to a predetermined reward scheme at the social network service if the determination is affirmative.

10. A computer program product stored in a computer-accessible non-transitory medium, comprising a computer-readable program executable on a computer system to implement the steps of:
(a) creating a stage model according to at least a performing parameter of an activity, wherein the stage model comprises a first stage and a second stage, wherein a value of the at least a performing parameter for use in the first stage is less than a value of the at least a performing parameter for use in the second stage;
(b) receiving initial activity data of each of a plurality of users at a social network service, and determining the users involved in the first stage according to the initial activity data and the value of the at least a performing parameter for use in the first stage;
(c) teaming the users involved in the first stage;
(d) communicating to the users teamed in a same team in step (c) via the social network service the value of the at least a performing parameter for use in the second stage, setting a team goal to achieve the value, and waiting for feedback from the users in the same team;
(e) determining whether the team goal is achieved according to the at least a performing parameter value replied by the users teamed in the same team in step (c), and moving the users in the same team to the second stage if the determination is affirmative; and
(f) providing rewards to the users in the same team according to a predetermined reward scheme at the social network service, if the determination is affirmative.

11. A computer system, comprising:
a host, comprising:
a bus system;
a memory connected to the bus system, wherein the memory comprises a computer executable instructions; and
a processing unit connected to the bus system, wherein the processing unit executes the computer executable instructions to thereby implement the steps of:
(a) creating a stage model according to at least a performing parameter of an activity, wherein the stage model comprises a first stage and a second stage, wherein a value of the at least a performing parameter for use in the first stage is less than a value of the at least a performing parameter for use in the second stage;
(b) receiving initial activity data of each of a plurality of users at a social network service, and determining the users involved in the first stage according to the initial activity data and the value of the at least a performing parameter for use in the first stage;
(c) teaming the users involved in the first stage;
(d) communicating to the users teamed in a same team in step (c) via the social network service the value of the at least a performing parameter for use in the second stage, setting a team goal to achieve the value, and waiting for feedback from the users in the same team;
(e) determining whether the team goal is achieved according to the at least a performing parameter value replied by the users teamed in the same team in step (c), and moving the users in the same team to the second stage if the determination is affirmative; and
(f) providing rewards to the users in the same team according to a predetermined reward scheme at the social network service, if the determination is affirmative.
